(19) United States
(12) Patent Application Publication
(10) Pub. No.: US 2024/0152771 A1
(43) Pub. Date: May 9, 2024

(54) TABULAR DATA MACHINE-LEARNING MODELS

(71) Applicant: Adobe Inc., San Jose, CA (US)

(72) Inventors: Can Qin, Somerville, MA (US); Sungchul Kim, San Jose, CA (US); Tong Yu, Fremont, CA (US); Ryan A. Rossi, San Jose, CA (US); Handong Zhao, Cupertino, CA (US)

(73) Assignee: Adobe Inc., San Jose, CA (US)

(21) Appl. No.: 17/979,843

(22) Filed: Nov. 3, 2022

(51) Int. Cl. G06N 5/02

(52) U.S. Cl. CPC G06N 5/02

(57) ABSTRACT

Tabular data machine-learning model techniques and systems are described. In one example, common-sense knowledge is infused into training data through use of a knowledge graph to provide external knowledge to supplement a tabular data corpus. In another example, a dual-path architecture is employed to configure an adapter module. In an implementation, the adapter module is added as part of a pre-trained machine-learning model for general purpose tabular models. Specifically, dual-path adapters are trained using the knowledge graphs and semantically augmented trained data. A path-wise attention layer is applied to fuse a cross-modality representation of the two paths for a final result.

### BACKGROUND

Machine-learning models are utilized in an ever increasing variety of scenarios to provide expanded functionality by computing devices. Machine learning is a type of artificial intelligence that is configured to learn from, and make predictions on, known data by analyzing training data to learn to generate outputs that reflect patterns and attributes of the training data. As such, machine-learning models are not explicitly programmed but rather are implemented as a computer representation that can be tuned (e.g., trained) automatically and without user intervention based on inputs using training data to approximate unknown functions. Conventional techniques used to train and implement machine-learning models, however, often fail, are inaccurate, and hinder computing device operation when confronted with challenges involved with tabular data and a corresponding mix of semantic and non-semantic content in the data.

### SUMMARY

Tabular data machine-learning model techniques and systems are described that overcome operational limitations of conventional techniques to improve training and use of machine-learning models involving tabular data. In one example, a machine-learning model is trained by a machine-learning system using a tabular data corpus have a plurality of items of tabular data. Training of the machine-learning module is augmented using a knowledge graph as a source of external knowledge. As a result, the knowledge graph is usable to introduce external “common-sense” knowledge as part of the tabular data and overcomes conventional challenges that are limited by sparseness of semantic content in tabular data.

The machine-learning model is configurable in a variety of ways. In one example, the machine-learning model is adapted from a pretrained machine-learning model, e.g., as adapter layers disposed between transformer layers of the model. During training in one example, the transformer layers are fixed whereas adapter layers are configured to learn from the training data.

The adapter module is also configurable in a variety of ways. In one example, the adapter module is configured as part of a dual-path architecture through use of a tabular adapter module and a knowledge adapter module. The knowledge adapter module is trained using a knowledge graph. The tabular adapter module, on the other hand, is trained using samples formed by aligning tabular data with the knowledge graph. An attention layer is also employed in this example to weight contributions from the two paths. As a result, the adapter module is configured to address domain differences in the knowledge graph and the tabular data.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ tabular data machine-learning model techniques described herein.

FIG. 2 depicts a system in an example implementation showing operation of a machine-learning system of FIG. 1 in greater detail.

FIG. 3 depicts a system in an example implementation showing operation of a training data generation module of FIG. 2 in greater detail.

FIG. 4 depicts a system in an example implementation showing operation of a model training module of FIG. 2 in greater detail as adapting a pre-trained machine learning model using an adapter module.

FIG. 5 depicts a system in an example implementation showing incorporation of an adapter module of FIG. 4 as an adapter layer within a machine-learning model having a transformer architecture.

FIG. 6 depicts a system in an example implementation showing incorporation of an adapter module having a dual-path architecture.

FIG. 7 depicts a system in an example implementation showing incorporation of an adapter module as adapter layers disposed between transformer layers of a machine-learning model having a transformer architecture.

FIG. 8 depicts a system in an example implementation showing operation of a model use module of FIG. 2 in greater detail.

FIG. 9 depicts an implementation showing examples of axis-type detection, outlier detection, axis-relation detection, and table-type detection as performed by respective modules of FIG. 8.

FIG. 10 depicts a procedure in an example implementation of training data generation, use of the training data to train a machine-learning model, and use of the trained machine-learning model.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

Overview

Machine-learning models are utilized in an ever-increasing variety of scenarios to provide expanded functionality by computing devices. This is performed by leveraging an ability of the machine-learning model to reflect patterns and attributes learned from training data. Conventional techniques used to train and implement machine-learning models, however, often fail and are inaccurate when confronted with challenges involved with tabular data.

Tabular data includes a plurality of values arranged along one or more axes, respectively, e.g., rows and/or columns of a table. Tabular data is typically formed as a mix of semantic and non-semantic content. It has been identified as part of the techniques described herein that approximately thirty percent of tabular data is semantic content. Semantic content is a primary technique, in which, insight is gained and understanding achieved into “what” is being represented by the values and thus learn from the data in order to train a machine-learning model. In real-world scenarios, however, semantic content is typically surrounded and isolated by relatively large amounts of irregular characters, e.g., number, strings, symbols, and so forth. Accordingly, conventional techniques used to train a machine-learning model are hindered by sparsity and isolation of semantic content in tabular data, which causes inaccuracy and hinders operational efficiency of computing devices that implement these techniques.

Accordingly, tabular data machine-learning model techniques and systems are described. These techniques overcome operational limitations of conventional techniques to improve training and use of machine-learning models involving tabular data. In one example, a machine-learning model is trained by a machine-learning system using a tabular data corpus having a plurality of items of tabular data. The tabular corpus, for instance, is configurable as a collection of tables formed using cells having values and identifiers (e.g., headers) providing a semantic description of a type of data represented by the values, e.g., power usage, device operation, times, locations, temperatures, and so forth.

Training of the machine-learning module is augmented in this example using a knowledge graph. The knowledge graph includes a plurality of nodes representative of entities (e.g., names, locations, etc.) and a plurality of connections between the plurality of nodes. The connections represent concepts that provide a link between respective entities, e.g., “is related to,” “an antonym of,” “a synonym of,” and so forth.

In order to generate training data, a training data generation module aligns the tabular data with the knowledge graph. Samples are then generated by selecting entities and their relationships from the aligned knowledge graph. The samples, for instance, are configured as positive triplet sets or negative triplet sets. Each triplet set defines first and second entities taken from the aligned knowledge graph and a relationship connecting those entities, e.g., “USA, Canada, is next to.” The training data is then used to train a machine-learning model, e.g., having a transformer architecture. As a result, the knowledge graph is usable to introduce external “common-sense” knowledge as part of the tabular data and overcomes conventional challenges that are limited by sparseness and isolation of semantic content in tabular data.

The machine-learning model is configurable in a variety of ways. In one example, the machine-learning model is adapted from a pretrained model. A pre-trained machine-learning model is obtained, for instance, that is configured in accordance with a transformer architecture. An adapter module is then added to this transformer architecture, e.g., as adapter layers disposed between transformer layers of the machine-learning model. In one example, the transformer layers are kept fixed during training whereas the adapter layers are trained using the training data.

The adapter module is also configurable in a variety of ways. In one example, a single path architecture is employed, e.g., as an adapter layer disposed between a dropout layer and a layer normalization layer of the transformer architecture. In another example, the adapter module is configured as part of a dual path architecture through use of a tabular adapter module and a knowledge adapter module. The knowledge adapter module is trained using a knowledge graph (e.g., unaligned) as described above. The tabular adapter module, on the other hand, is trained using the samples taken from the aligned knowledge graph formed from the tabular data, e.g., the positive and/or negative triplets. An attention layer is also employed in this example to weight contributions from the two paths. In this way, training of the machine-learning model is improved by leveraging transfer learning that leverages insight indicating that low to mid-level representations are shared across similar tasks and therefore general representations are enhanced by external knowledge provided by the knowledge graph.

The machine-learning model, once trained, is usable to support a variety of usage scenarios. Examples of these usage scenarios include generation of tabular-data type predictions, examples of which include column type prediction, relation prediction, outlier cell prediction, table classification, column-based embedding retrieval, entity-based embedding retrieval, and so forth.

Conventional techniques, for instance, often fail when confronted with tabular data due to data sparsity, isolation, and lack of semantic content in tabular data. For example, use of tabular machine-learning models have received increasing attention due to the wide-ranging applications for tabular data analysis. Conventional techniques are directly built upon the tabular data with a mixture of non-semantic and semantic contents. However, in practice typically thirty percent of tabular data includes semantic entities that are surrounded and isolated by significant amounts of irregular characters such as numbers, strings, symbols, etc. These semantic entities form a significant basis for table understanding.

In the techniques described herein, tabular machine-learning models are enhanced by injecting common-sense knowledge from external sources. As a result, the tabular machine-learning model overcomes domain gaps between external knowledge and tabular data with significant differences in both structure and content. In an example, two parallel adapters are included within a pre-trained tabular model for flexible and efficient knowledge injection. The two parallel adapters are trained by knowledge graph triplets and semantically augmented tables respectively for infusion and alignment with the tabular data. In addition, a path-wise attention layer is attached below to fuse the cross-domain representation with the weighted contribution. As a result, the techniques described herein overcome conventional challenges of data sparsity, isolation, and lack of semantic content in tabular data. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

Example Environment

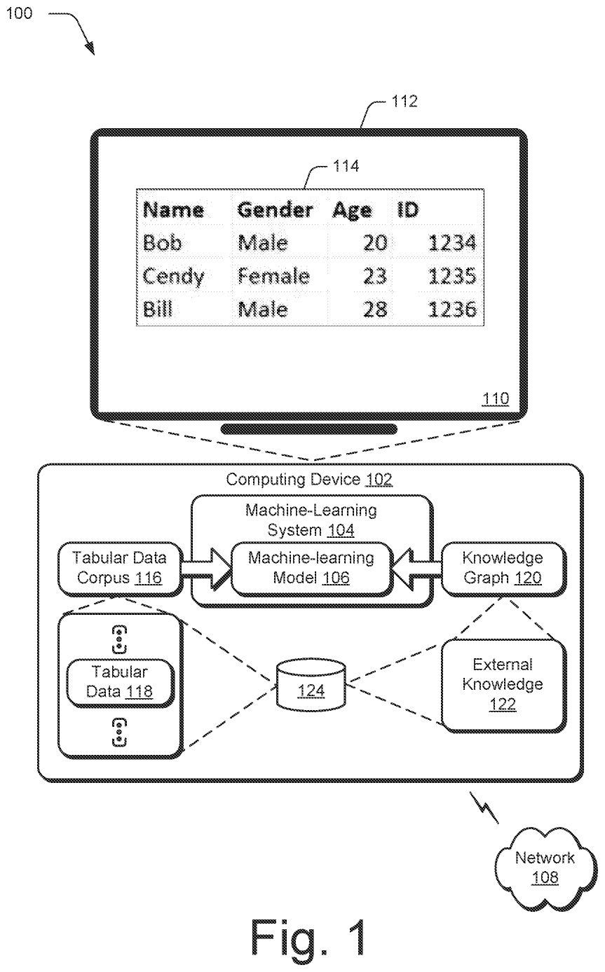

FIG. 1 is an illustration of a digital medium environment 100 in an example implementation that is operable to employ tabular data machine-learning model techniques described herein. The illustrated environment 100 includes a computing device 102, which is configurable in a variety of ways.

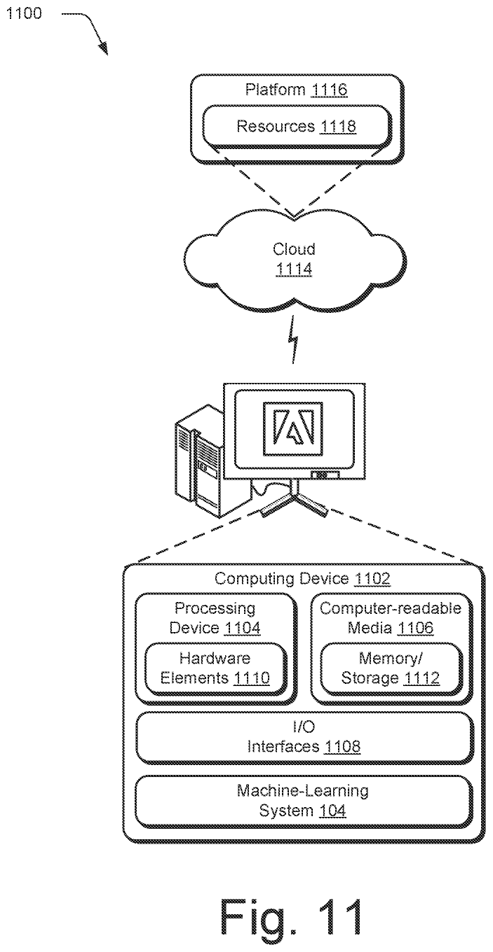

The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 11.

The computing device 102 includes a machine-learning system 104. The machine-learning system 104 is representative of functionality to generate training data, train a machine-learning model 106 using the training data, and/or implement functionality using the machine-learning model 106 once trained. Although illustrated as implemented locally at the computing device 102, functionality of the machine-learning system 104 is also configurable as whole or part via functionality available via the network 108, such as part of a web service or “in the cloud.”

The machine-learning system 104 in this example is configured to address challenges of conventional techniques to permit use of tabular data by the machine-learning model 106. In an example user interface 110 displayed by a display device 112, tabular data 114 is depicted having values arranged along an axis (e.g., columns) in a table. Other examples are also contemplated, e.g., arranged as rows, as a single vector, and so forth. The tabular data 114 includes both semantic content and non-semantic content. The semantic content, for instance, identifies characteristics of values along an associated axis, e.g., name, gender, age, and ID. The non-semantic content specifies the values in this example numerically, although other examples are also contemplated.

The machine-learning model 106 is usable to support a variety of functionality involving tabular data, such as table interpretation, augmentation, question answering, and so on. Conventional techniques, however, are incapable of addressing challenges involving inclusion of both semantical and non-semantical characters (e.g., irregular characters) as part of tabular data. Unlike natural language processing, seventy percent of tabular data (e.g., headers and cells) is typically implemented using non-semantic content, e.g., includes numbers, string, or symbols. As such, a remaining thirty percent of tabular data includes semantic content. Semantic content, however, provides a primary basis for understanding “what” is represented by the values. Therefore, conventional techniques are challenged in learning semantical dependencies by noise caused by inclusion irregular characters and out-of-vocab (OOV) strings with unique meanings. In conventional techniques, this causes bias of machine-learning models trained on this data towards non-semantical content and corresponding operational inaccuracies.

To address these technical challenges, the machine-learning system 104 is configured to train the machine-learning model 106 using a tabular data corpus 116 of tabular data 118 and a knowledge graph 120 that provides a source of external knowledge 122. The tabular data corpus 116 of tabular data 118 and the knowledge graph 120 that provides the source of external knowledge 122 are illustrated as stored in a storage device 124, e.g., memory.

The machine-learning system 104 implements a framework to efficiently embed external knowledge 122 for semantical representation enhancement. Additionally, the machine-learning system 104 supports cross-domain representation of tabular data 118 and external knowledge 122 through use of a dual-path architecture employing adapter modules with a path-wise attention layer for contribution weighting. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Tabular Data Machine-Learning Models

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-10.

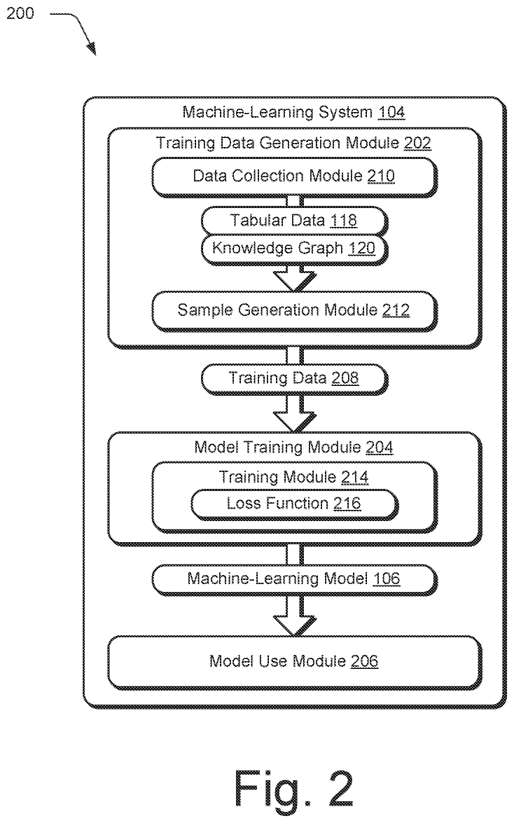

FIG. 2 depicts a system 200 in an example implementation showing operation of the machine-learning system 104 of FIG. 1 in greater detail. The machine-learning system 104 includes a training data generation module 202, a model training module 204, and a model use module 206.

The training data generation module 202 is configured to generate training data 208 that serves as a basis to train the machine-learning model 106. To do so, the training data generation module 202 includes a data collection module 210 configured to collect tabular data 118 and a knowledge graph 120. The tabular data 118 includes a plurality of values arranged along a plurality of axes, respectively. The axes, for instance, are configurable as rows and/or columns in a table format. The values are disposed in cells along the axes.

The knowledge graph 120 includes a plurality of nodes representative of entities and a plurality of connections between the plurality of nodes representative of respective concepts. The knowledge graph 120 supports use of logical inferences and implicit knowledge. Therefore, use of the knowledge graph 120 to train the machine-learning model 106 provides external knowledge 122 regarding conceptual similarity and derivation of latent feature representations of the entities and relationships as part of the graph. The tabular data 118 and the knowledge graph 120 are used as a basis to generate samples by a sample generation module 212 to form the training data 208, an example of which is further described in greater detail below.

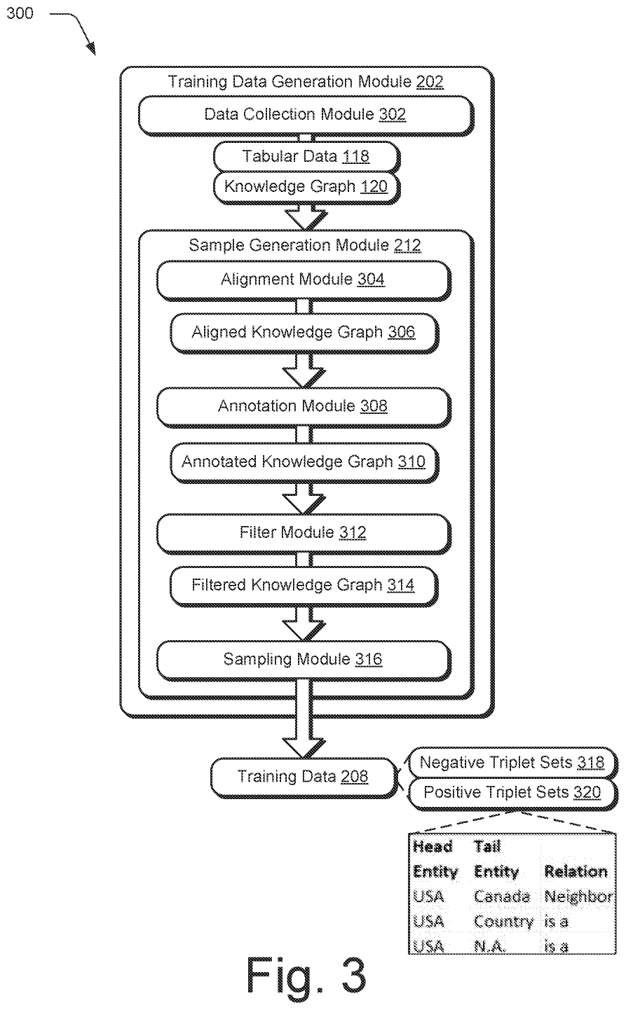

FIG. 3 depicts a system 300 in an example implementation showing operation of a training data generation module 202 of FIG. 2 in greater detail. A data collection module 302 is employed to first obtain tabular data 118 and a knowledge graph 120. The tabular data 118, for instance, is obtainable from a digital service, e.g., Wikipedia®, Common Crawl, etc. See Kevin Hu, Snehalkumar'Neil'S Gaikwad, Madelon Hulsebos, Michiel A Bakker, Emanuel Zgraggen, César Hidalgo, Tim Kraska, Guoliang Li, Arvind Satyanarayan, and Ça\check{g}atay Demiralp. 2019. Viznet: Towards a large-scale visualization learning and benchmarking repository. In CHI. 1-12, the entire disclosure of which is hereby incorporated by reference. In another instance, the knowledge graph 120 is obtained from ConceptNet. See Robyn Speer, Joshua Chin, and Catherine Havasi. 2017. Conceptnet 5.5: An open multilingual graph of general knowledge. In AAAI, the entire disclosure of which is also incorporated by reference.

In general, the tabular data 118 (in its “raw form”) is aligned with the knowledge graph 120 by an alignment module 304, e.g., by aligning entities of the tabular data 118 with entities in the knowledge graph 120. An annotation module 308 is then employed to extract entities from the aligned knowledge graph 306 to form an annotated knowledge graph 310. The annotated knowledge graph 310 is then filtered by a filter module 312 (e.g., to remove numbers, non-sematic characters, etc.) to form a filtered knowledge graph 314. A sampling module 316 then generates samples from the filtered knowledge graph 314 to form the training data 208 as including negative triplet sets 318 and positive triplet sets 320.

To do so, named entities and underlying relationships are extracted from the knowledge graph 120. In an implementation, a pre-defined parsing rule is applied to match similarity of tabular cells of the tabular data 118 with the entities of the knowledge graph 120 in a semantic space. Finally, filtered entities from the filter module 312 and generated filtered knowledge graph 314 (formed by removing non-semantic values) are selected by the module 316 to form the triplets as aligned external knowledge.

Triplets of the negative triplet sets 318 and positive triplet sets 320, for instance, reference a first entity and second entity from the aligned knowledge graph 306 as well as a relationship between those entities. In the illustrated example, positive triplet sets 320 follow a <first entity,> <second entity,> <relationship> convention and include “USA, Canada, Neighbor,” “USA, Country, is a,” and “USA, N.A., is a.” Negative triplet sets 318 are also configurable in a variety of ways, such as through editing of the positive triplet sets 320 to include erroneous information, e.g., from other portions of the filtered knowledge graph 314 to include other entities and/or relationships.

The training data 208, once generated, is passed from the training data generation module 202 to a model training module 204 to train the machine-learning module 106. To do so, a training module 214 employs one or more loss functions 216 to tune a computer representation of the machine-learning model 106 to approximate unknown functions based on the training data 208. In particular, the training of the machine-learning model 106 using the training module 214 leverages algorithms to learn from, and make predictions on, known data by analyzing training data to learn to generate outputs that reflect patterns and attributes of the training data. Examples of machine-learning models include transformer networks, neural networks, convolutional neural networks (CNNs), long short-term memory (LSTM) neural networks, decision trees, and so forth.

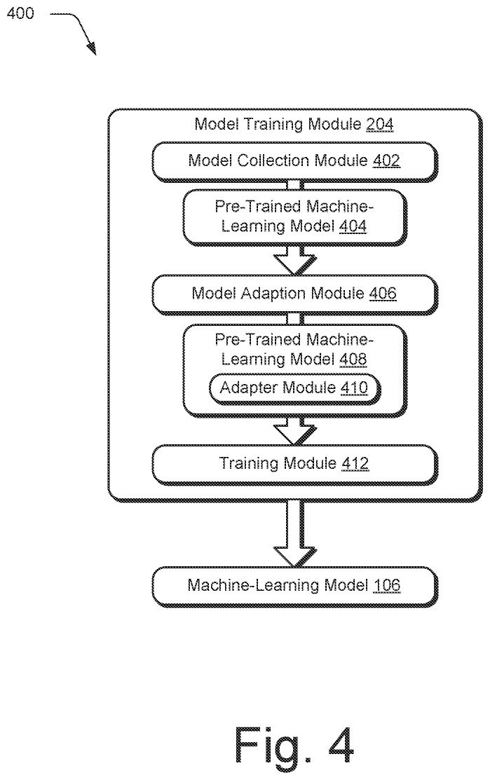

FIG. 4 depicts a system 400 in an example implementation showing operation of a model training module 204 of FIG. 2 in greater detail as adapting a pre-trained machine learning model. In this example, a model collection module 402 is employed to collect a pre-trained machine-learning model 404 that is then subsequently adapted by a model adaption module 406 for training by a training module 412. To do so, an adapter module 410 is added to the pre-trained machine-learning model 408 that, one trained, forms the machine-learning model 106.

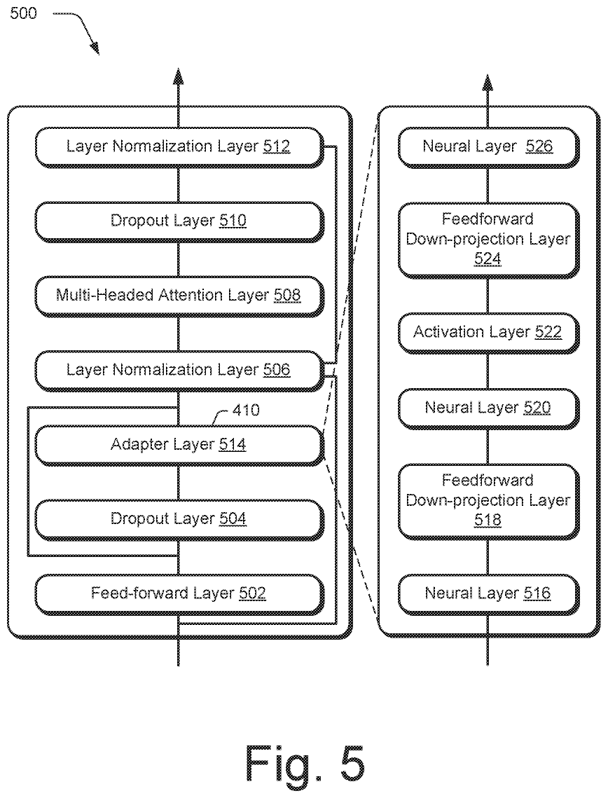

FIG. 5 depicts a system 500 in an example implementation showing incorporation of an adapter module as an adapter layer within a machine-learning model having a transformer architecture, i.e., is a “transformer machine-learning model,” “transformer model,” or “transformer network.” The transformer architecture supports bidirectional processing to learn context through tracked relationships to derive a meaning of an input. To do so, a transformer model employing this architecture utilizes a self-attention mechanism to weight significance of parts of an input on achieving a result.

In the illustrated example, a feed-forward layer 502 is first employed, followed by a dropout layer 504, layer normalization layer 506, multi-headed attention layer 508, another dropout layer 510, and a layer normalization layer 512. An adapter layer 514 implements the adapter module 410. The adapter layer 514 includes a neural layer 516 followed by a feedforward down-projection layer 518, neural layer 520, activation layer 522, another feedforward down-projection layer 524, and a neural layer 526. The multi-headed attention layer 508 implements a self-attention mechanism to calculate weights indicating an amount of relevance of respective parts of an input to other parts of the input.

This example begins with a general purpose pre-trained machine-learning model 408. Layers of the pre-trained machine-learning model 408 are pretrained using tabular data, e.g., the feed-forward layer 502, dropout layer 504, layer normalization layer 506, multi-headed attention layer 508, dropout layer 510, and layer normalization layer 512. An example of a pre-trained machine-learning model 408 includes “TABBIE.” See Hiroshi Jida, Dung Thai, Varun Manjunatha, and Mohit Iyyer. 2021. TABBIE: Pretrained Representations of Tabular Data. arXiv:2105.02584 [cs.CL], which is hereby incorporated by reference in its entirety.

In the example pre-trained machine-learning model 404, two different transformers are applied for learning row and column representations to collect a row-wise embedding set “R={ri,1, ri,2, . . . , ri,N}” and a column-wise embedding set “C={ci,1, ci,2, . . . , ci,M}.” The pre-trained machine-learning model 404 takes an “M×N” table as an input and outputs embeddings “X={xᵢⱼ|i=1, . . . , M, j=1, . . . , N}” for each cell. Specifically, the contextualized cell embedding is an average of row embedding and column embedding:

r_{i,j}^{L}=ϕ_{θ}_{ᵣ}(x_{i,j}^{L}), (1)

c_{i,j}^{L}=ϕ_{θ}_{_{c}}(x_{i,j}^{L}), (2)

x_{i,j}^{L+1}=(r_{i,j}^{L}+c_{i,j}^{L})/2, (3)

where “L” denotes the index of transformer layer, and “θᵣ” and “θ_{c}” represent parameters of a row transformer and column transformer, respectively. The subscripts “i” and “j” denote coordinates of the cell at the “i-th” column and “j-th” row. The pre-trained machine-learning model 404 adopts corruption loss by predicting whether the cell is corrupted:

p_{i,j}=σ(w^{T}x_{i,j}^{L}), (4)

where “σ(⋅)” denotes a Sigmoid function and “w” represents a projection matrix for outlier cell prediction. In an example, such outlier cells are generated using self-supervision by automatically swapping and removing cells with labels as either “0” or “1” to represent “polluted” or “not polluted.” Therefore, the pre-training objective is a binary cross entropy loss:

$${ℒ}_{task} = \frac{1}{MN} {\sum }_{i = 1}^{M} {\sum }_{j = 1}^{N} {y}_{i , j} log {p}_{i , j} + ( 1 - {y}_{i , j} ) log ( 1 - {p}_{i , j} ) , \qquad ( 5 )$$

where “y_{i,j}” is a cell-wise corruption label.

The adapter module 410 and example adapter layer 514 as part of the pre-trained machine-learning model 408 are employed to improve efficiency in training the machine-learning model. This is performed by leveraging a realization that low/mid-level representations are shared across similar tasks in transfer learning. Therefore, operation of the pre-trained machine-learning model 408 is enhanced by the adapter module 410 to incorporate external knowledge 122 from the knowledge graph 120.

In the illustrated example of FIG. 5, the adapter layer 514 is implemented between a dropout layer 504 and layer normalization layer 506, which is represented as:

ϕ_{θ}_{_{ad}}(h)=h+wᵤ^{T}ƒ(w_{d}^{T}h+b_{d})+bᵤ, (6)

where “h” is an embedding of a previous layer and “w_{d}” and “wᵤ” represent downscale and upscale projection matrices, respectively, with corresponding bias weights as “bd” and “bu.” A value “ƒ(⋅)” represents an activation function, e.g., such as a rectified linear unit active function (ReLU).

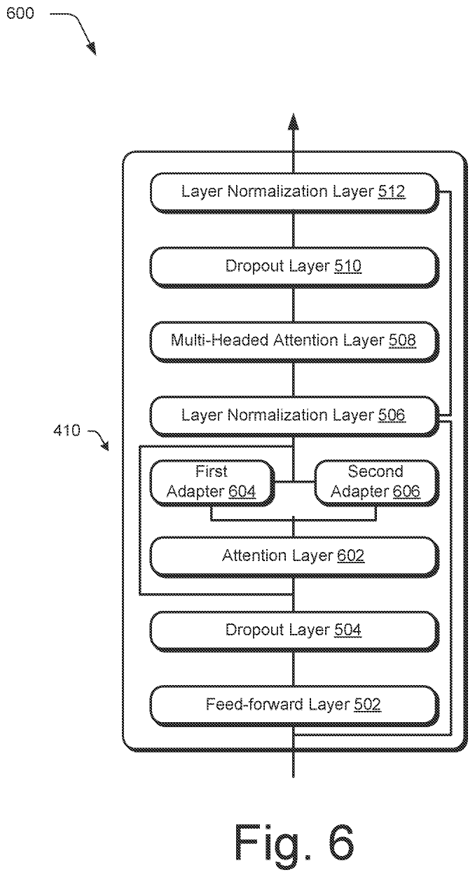

FIG. 6 depicts a system 600 in an example implementation showing incorporation of an adapter module as an adapter layer within a machine-learning model having a transformer architecture formed according to a dual-path architecture. Alignment is usable to bridge a gap between domains of the tabular data 114 and the external knowledge 122 of the knowledge graph 120. Accordingly, in this example the adapter module 410 is implemented using a dual-path architecture through use of an attention layer 602, a first adapter 604, and a second adapter 606. The first adapter 604 is implemented as a tabular adapter module and the second adapter 606 is implemented as a knowledge adapter module.

The tabular adapter module is parameterized by “θₖ” and “θₜ,” respectively, given different input data. In an implementation, the knowledge adapter module “ϕ(⋅)θk” is trained solely by the external knowledge 122 of the knowledge graph 120. The tabular adapter module, on the other hand, is trained by the semantically augmented tabular data formed from the samples in the training data 208 as described in relation to FIG. 3. During training to implement downstream finetuning, both the first and second adapters 604, 606 are updated using the attention layer 602 to weight the contributions from the two paths:

Adapter(h)=wₖϕ_{θ}_{ₖ}(h)+wₜϕ_{θ}_{ₜ}(h), (7)

where path-wise weights “wₖ” and “wₜ” are computed using a multi-layer perceptron (MLP) layer as:

[wₜ,wₖ]=MLP_{θ}_{ₐₜₜ}(h), (8)

where “h∈R^{d}” denotes a cell embedding.

As previously described, the external knowledge to be injected into the pre-trained model originates from the knowledge graph 120. In the following discussion, the knowledge graph 120 is denoted as “KG=(E, R, T),” where “E={e1, . . . , eN}” is a set of entities and “R={r1, . . . , rP}” is a relation set. The value:

T={(et1i,rt2i,et3i)|1≤i≤T,et1i,et3i∈E,rt2i∈R}

represents the head-relation-tail triplet set. The value:

Nv={(r,u)|(v,r,u)∈T}

represents a set of neighboring relations and entities of an entity “v” which is also considered as the positive (i.e., “correct”) data.

In one example of knowledge representation learning, a tail entity is represented as a sum of a head entity (i.e., first entity) embedding and relation embedding:

\vec{h}+\vec{r}=\vec{t}

where

(\vec{h},\vec{r},\vec{t})∈S.

Negative triples

(\vec{h}′,\vec{r}′,\vec{t}′)∈S′

do not satisfy this constraint. To this end, the loss is defined as:

$${ℒ}_{TransE} = {\sum }_{( h , r , t ) ∈ S} {\sum }_{( {h}^{′} , r , {t}^{′} ) ∈ {S}^{′}} [ γ + d ( h + r , t ) - d ( {h}^{′} + r , {t}^{′} ) ] , \qquad ( 9 )$$

to maximize a difference between positive and negative triplet sets.

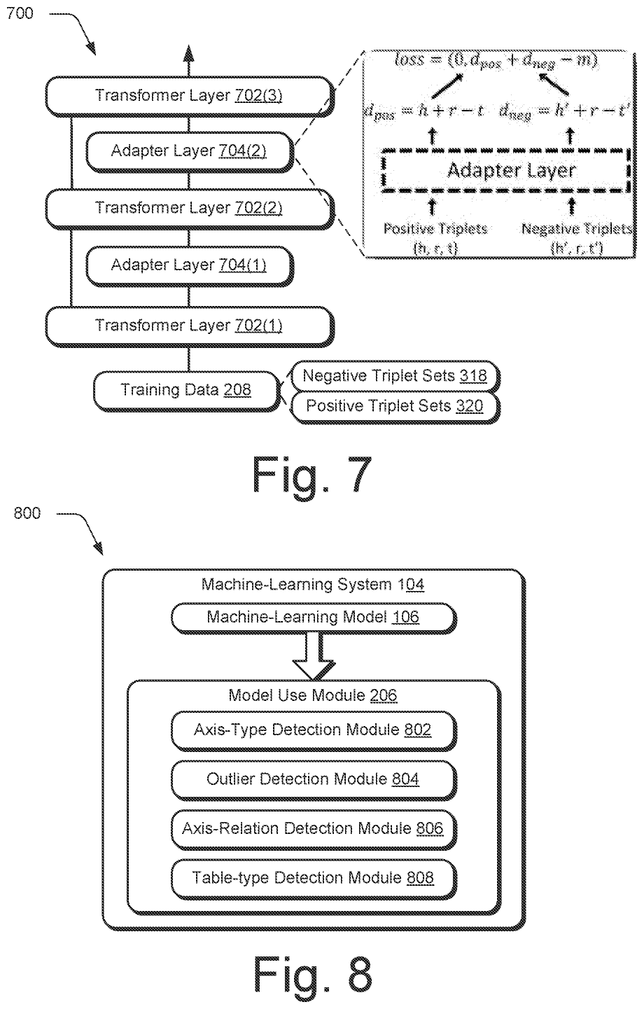

FIG. 7 depicts a system 700 in an example implementation showing incorporation of an adapter module as adapter layers disposed between transformer layers of a machine-learning model having a transformer architecture. The transformer architecture is illustrated as receiving the training data 208. The transformer architecture includes a plurality of transformer layers 702(1), 702(2), 702(3). Adapter layers 704(1), 704(2) are disposed between the transformer layers. Continuing with the previous example, in order to ensure dense knowledge injection, multilayer training is implemented where the loss is computed in both a final layer and the higher adapter layers using positive and negative triplet sets:

dₚₒₛ=h+r−t

d_{neg}=h′+r−t′

loss=(0,dₚₒₛ+d_{neg}−m)

As discussed above, the dual-path architecture implemented by the first and second adapters 604, 606 addresses a domain gap between tabular data 118 and the external knowledge 122 of the knowledge graph 120. In order to train the adapter module 410 in this configuration, iterative optimization is utilized by a training module 214 using a loss function 216 that includes a task loss and knowledge loss on different inputs. The final training losses are:

$${\hat{θ}}_{att} , {\hat{θ}}_{t} , {\hat{θ}}_{k} = {arg min}_{{θ}_{att} , {θ}_{t} , {θ}_{k}} {ℒ}_{task} ( X ) + {ℒ}_{TransE} ( S , {S}^{′} ) , \qquad ( 10 )$$

where the two losses are iteratively optimized, and values of:

\hat{θ}ₐₜₜ,\hat{θ}ₜ,\hat{θ}ₖ

denote updated parameters of a path-wise attention network, tabular adapter and knowledge adapter, respectively.

The machine-learning model 106, once trained by the model training module 204, is passed as an input to the model use module 206 in support of a variety of functionality by the machine-learning system 104. FIG. 8 depicts a system 800 in an example implementation showing operation of a model use module 206 of FIG. 2 in greater detail. A variety of types of functionality are configured to leverage use of the trained machine-learning model 106. Illustrated examples of functionality to do so include an axis-type detection module 802, an outlier detection module 804, an axis-relation detection module 806, and a table-type detection module 808. Other examples include column-based embedding retrieval and entity-based embedding retrieval.

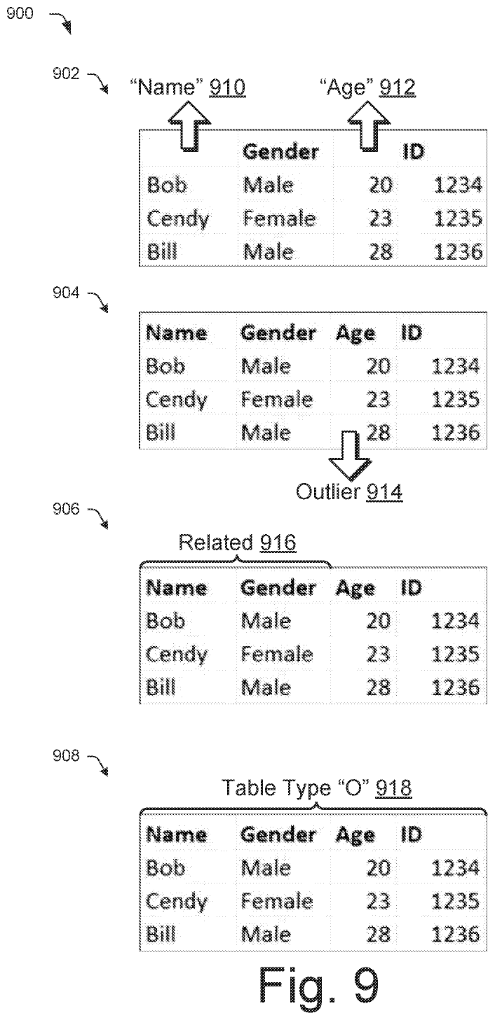

FIG. 9 depicts an implementation 900 showing examples of axis-type detection, outlier detection, axis-relation detection, and table-type detection as performed by respective modules of FIG. 8. This implementation is illustrated using a first example 902, a second example 904, a third example 906, and a fourth example 908. These examples describe varieties of tabular-data type predictions generated by the machine-learning model 106, once trained.

The first example 902 depicts axis-type detection in which a determination is made using the machine-learning model 106 by the axis-type detection module 802 as to a likely “type” of data represented by values disposed in a respective axis. The illustrated table, for instance, is received as an input by the trained machine-learning model 106. From this, the machine-learning model 106 generates an output indicating a likely type (i.e., a prediction) of a corresponding axis, e.g., a “name” 910 for a first axis and “age” 912 for a third axis.

In the second example 904, the outlier detection module 804 identifies which values in the table are considered outliers through processing by the trained machine-learning model 106. The machine-learning model 106 in this example identifies an age of “28” as the outlier 914.

In the third example 906, the axis-relation detection module 806 determines which axes in the table are related using the machine-learning model 106. The table, for instance, includes name, gender, age, and ID axes. From this, and corresponding values of the table, the machine-learning model 106 determines that the “name” and “gender” axes are related 916.

In the fourth example 908, the table-type detection module 808 determines an overall table “type” through use of the machine-learning model 106. The machine-learning model 106, for instance, processes the table to determine, based on values within cells of the table, as to an overall type, e.g., table type “O” 918 in the illustrated example. Other examples are also contemplated, including column-based embedding retrieval and entity-based embedding retrieval that are usable to retrieve machine-learning embeddings learned using the machine-learning model for the respective entities and/or columns.

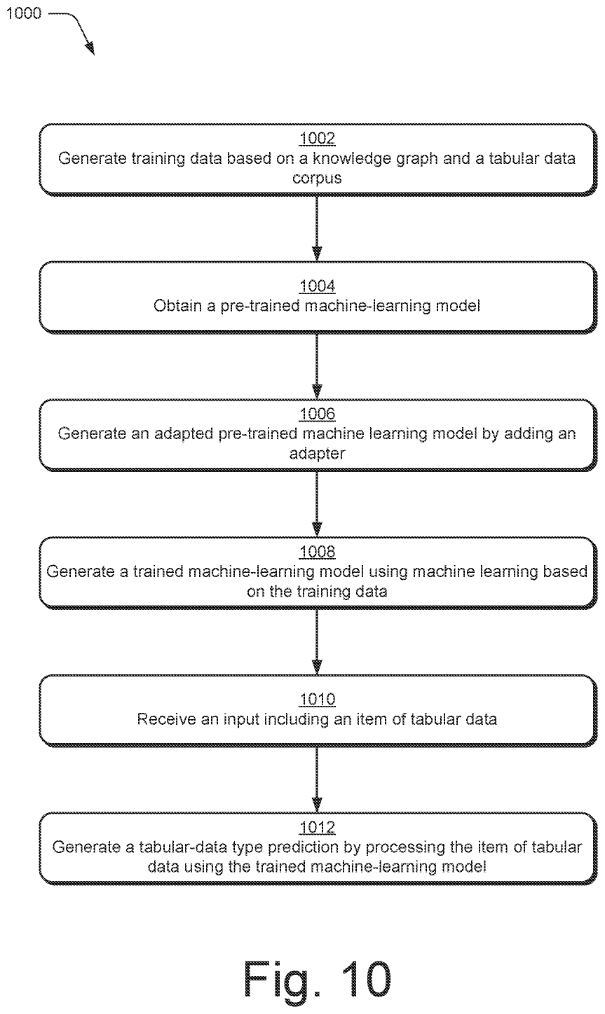

FIG. 10 depicts a procedure 1000 in an example implementation of training data generation, use of the training data to train a machine-learning model, and use of the trained machine-learning model. To begin, training data is generated based on a knowledge graph and a tabular data corpus (block 1002). In one example, a data collection module 210 collects the tabular data 118 and the knowledge graph 120 that provides external knowledge 122.

In a dual-path architecture example, two sets of data are included as part of the training data 208. A first set includes samples generated by aligning the tabular data 118 with the knowledge graph 120 to form an aligned knowledge graph 306. Samples are then taken from the aligned knowledge graph 306, e.g., as negative triplet sets 318 and positive triplet sets 320. This is used to the train a tabular adapter module. A second set includes samples taken from the knowledge graph 120, unaltered, which are then used to train a knowledge adapter module.

A pre-trained machine-learning model is obtained (block 1004). In one example, a model collection module 402 obtains the pre-trained machine-learning model 404. The pre-trained machine-learning model 404 is trained using general purpose tabular data. An adapted pre-trained machine-learning model is generated by adding an adapter to the pre-trained machine-learning model (block 1006). A model adaption module 406, for instance, then adds an adapter module 410 to the pre-trained machine-learning model 404 as described in relation to FIG. 4, example architectures of which are illustrated in FIGS. 5-7.

A trained machine-learning model is generated using machine learning based on the training data (block 1008). In a dual-path architecture, the first set of data included in the training data that is sampled from the aligned knowledge graph 306 is used to train the tabular adapter module. The second set of data included in the training data taken form the knowledge graph 120, solely, is used to train the knowledge graph module. In an implementation, this training is performed to train layers of the adapter module 410 while keeping layers included in the pre-trained machine-learning model 404 (e.g., transformer layers of FIG. 7) fixed during this subsequent training.

An input is received including an item of tabular data (block 1010). In response, a tabular-data type prediction is generated by processing the item of tabular data using the trained machine-learning model (block 1012). The machine-learning model 106 is trained in this example and as such is usable in support of a variety of functionality as part of generating the prediction. Examples of this functionality are represented as an axis-type detection module 802, an outlier detection module 804, an axis-relation detection module 806, and a table-type detection module 808 in FIG. 8. Other examples include column-based embedding retrieval and entity-based embedding retrieval.

The tabular data machine-learning model techniques described herein support improvements over conventional tabular pretraining techniques by infusing common-sense knowledge through use of a knowledge graph 120 to provide external knowledge 122 to supplement a tabular data corpus 116. Tabular data and corresponding training of machine-learning models is confronted with domain gaps between the external knowledge 122 of the knowledge graph 120 and the tabular data 118, e.g., in both structures and content. To address this in one example, a dual-path architecture is employed to configure an adapter module 410. In an implementation, the adapter module 410 is added as part of a pre-trained machine-learning model for general purpose tabular models. Specifically, dual-path adapters are trained using the knowledge graphs and semantically augmented trained data. A path-wise attention layer is applied to fuse a cross-modality representation of the two paths for a final result.

Example System and Device

FIG. 11 illustrates an example system generally at 1100 that includes an example computing device 1102 that is representative of one or more computing systems and/or devices that implement the various techniques described herein. This is illustrated through inclusion of the machine-learning system 104. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model,” which refers to a computer representation that can be tuned (e.g., trained) based on inputs to approximate unknown functions. In particular, the term machine-learning model can include a model that utilizes algorithms to learn from, and make predictions on, known data by analyzing training data to learn to generate outputs that reflect patterns and attributes of the training data. Examples of machine-learning models include neural networks, convolutional neural networks (CNNs), long short-term memory (LSTM) neural networks, transformer networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
generating, by a processing device, training data based on:
a knowledge graph; and
a tabular data corpus having a plurality of items of tabular data; and
generating, by the processing device, a trained machine-learning model using machine learning based on the training data, the trained machine-learning model configured to generate a tabular-data type prediction based on a subsequent item of tabular data.

2. The method as described in claim 1, wherein the tabular-data type prediction includes a column type prediction, a relation prediction, an outlier cell prediction, a table classification, column-based embedding retrieval, or entity-based embedding retrieval.

3. The method as described in claim 1, wherein:
the tabular data includes a plurality of values arranged along a plurality of axes, respectively; and
the knowledge graph includes a plurality of nodes representative of entities and a plurality of connections between the plurality of nodes representative of respective concepts.

4. The method as described in claim 1, wherein the generating includes generating an aligned knowledge graph by aligning the tabular data corpus with the knowledge graph.

5. The method as described in claim 4, wherein the generating includes forming a plurality of samples from the aligned knowledge graph.

6. The method as described in claim 5, wherein the plurality of samples includes a plurality of triplet sets, each said triplet set defining a first entity, a second entity, and a relationship between the first and second entities.

7. The method as described in claim 1, wherein the machine-learning model includes an adapter module having dual-path architecture including a tabular adapter module and a knowledge adapter module.

8. The method as described in claim 7, wherein the training includes:
training the tabular adapter module using a plurality of samples formed from an aligned knowledge graph generated by aligning the tabular data corpus with the knowledge graph; and
training the knowledge adapter module using the knowledge graph.

9. The method as described in claim 1, further comprising:
obtaining a pre-trained machine-learning model; and
generating an adapted pre-trained machine-learning model by adding an adapter to the pre-trained machine learning model, and wherein the generating the trained machine-learning model includes training the adapted pre-trained machine learning model.

10. The method of claim 9, wherein the training the adapted pre-trained machine learning model includes training the adapter and keeping layers of the pre-trained machine learning model fixed.

11. A machine-learning system comprising:
a transformer machine learning model having a plurality of transformer layers configured to implement a self-attention mechanism and an adapter module having a dual-path architecture including:
a tabular adapter module trained using a plurality of samples formed from an aligned knowledge graph, the aligned knowledge graph generated by aligning a plurality of items included in a tabular data corpus with a knowledge graph; and
a knowledge adapter module trained using the aligned knowledge graph.

12. The system as described in claim 11, wherein the transformer layers remain fixed during the training of the tabular adapter module and the knowledge adapter module of the adapter module.

13. The system as described in claim 11, wherein the tabular adapter module is trained using a plurality of samples formed from the aligned knowledge graph, the plurality of samples including a plurality of triplet sets, each said triplet set defining a first entity, a second entity, and a relationship between the first and second entities.

14. A non-transitory computer-readable storage medium storing executable instructions, which when executed by a processing device, cause the processing device to perform operations comprising:
receiving an input including an item of tabular data; and
generating a tabular-data type prediction by processing the item of tabular data using a machine-learning model, the machine-learning model trained based on a knowledge graph and a tabular data corpus having a plurality of items of tabular data.

15. The non-transitory computer-readable storage medium as described in claim 14, wherein the tabular-data type prediction includes a column type prediction, a relation prediction, an outlier cell prediction, a table classification, column-based embedding retrieval, or entity-based embedding retrieval.

16. The non-transitory computer-readable storage medium as described in claim 14, wherein machine-learning model is trained using a plurality of samples obtained from an aligned knowledge graph generated by aligning the tabular data corpus with the knowledge graph.

17. The non-transitory computer-readable storage medium as described in claim 16, wherein the plurality of samples includes a plurality of triplet sets, each said triplet set defining a first entity, a second entity, and a relationship between the first and second entities.

18. The non-transitory computer-readable storage medium as described in claim 14, wherein the machine-learning model includes an adapter module having dual-path architecture including a tabular adapter module and a knowledge adapter module.

19. The non-transitory computer-readable storage medium as described in claim 18, wherein:
the tabular adapter module is trained using a plurality of samples formed from an aligned knowledge graph generated by aligning the tabular data corpus with the knowledge graph; and
the knowledge adapter module is trained using the knowledge graph.

20. The non-transitory computer-readable storage medium of claim 18, wherein the machine-learning model is a transformer and layers of the adapter module are disposed between transformer layers of the transformer.
